(19) United States
(12) Patent Application Publication
(10) Pub. No.: US 2013/0251857 A1
(43) Pub. Date: Sep. 26, 2013

(54) FROSTED CEREAL FOOD AND PRODUCTION METHOD THEREOF

(71) Applicant: Hiroyuki Mitobe, Koshigaya-shi (JP)

(72) Inventor: Hiroyuki Mitobe, Koshigaya-shi (JP)

(73) Assignee: Kao Corporation, Chuo-ku, Tokyo (JP)

(21) Appl. No.: 13/825,258

(22) PCT Filed: Sep. 20, 2011
(86) PCT No.: PCT/JP2011/071331

§ 371 Date: Jun. 10, 2013

(30) Foreign Application Priority Data
Sep. 21, 2010 (JP) 2010-210899

(51) Int. Cl. A23L 1/30; A23L 1/164

(52) U.S. Cl. CPC A23L 1/3002; A23L 1/1641
USPC 426/93; 426/302

(57) ABSTRACT

A frosted cereal food containing catechins in an amount of 0.1 mass % or more with respect to the dry mass of the frosted cereal food, wherein the frosted cereal food includes a coating material containing a solid content other than saccharides in an amount of 1 mass % or more, the solid content other than saccharides containing the catechins in an amount of 40 mass % or more.

### FIELD OF THE INVENTION

The present invention relates to a frosted cereal food (a cereal food coated with sugar) containing catechins and a production method thereof.

### BACKGROUND OF THE INVENTION

It is known that catechins have physiological functions such as α-amylase activity inhibitory function and a cholesterol absorption inhibitory function, in addition to their well-known function as antioxidants (see Patent Literatures 1 and 2), and incorporation of cathechins into various foods has been studied in recent years. Since catechins are added to foods, catechins derived from plants such as teas, grapes, apples and soybeans are widely used.

A cereal food blended with powdered green tea was marketed as a cereal food containing catechins. Furthermore, although not a cereal food, a cereal bar containing a trace amount of catechins together with vitamins A and E is known as a catechin preparation-containing food (see Patent Literature 3).

As mentioned above, there were known a number of cereal foods and cereal-related foods blended with powdered green tea for imparting tea flavor or blended with a catechin preparation for preventing oxidation.

Further, when catechins are used as antioxidants, the purpose is attained by adding a crude catechin preparation to a cereal food in an amount of 0.1 to 0.2 mass %.

### CITATION LIST

### Patent Literatures

Patent Literature 1: JP-A-60-156614 (“JP-A” means unexamined published Japanese patent application)
Patent Literature 2: JP-A-3-133928
Patent Literature 3: EP 1844664 A1

### SUMMARY OF THE INVENTION

In order for catechins to effectively exert a physiological effect upon ingestion of a food containing the catechins, it is necessary to incorporate the catechins in the food at such a concentration that an amount effective for achieving the intended physiological effect is established relative to the amount of the food ingested.

When a frosted cereal food is selected as the food, two methods are available for incorporating catechins. One is a method in which catechins are kneaded into a dough during the production of the cereal food, and the other is a method in which catechins are incorporated into a saccharide solution used for making the frosted cereal, and coating a cereal food with this. Although the former method is easier, when powdered green tea is used as a catechin raw material, the content of the catechins in the powdered green tea is around 10 mass % (unless otherwise specified, mass % indicating content is hereinafter abbreviated to %). The amount of the powdered green tea blended into the cereal food is therefore 10 times higher than that necessary to establish the required amount of the catechins. Furthermore, when a commercially available catechin preparation obtained by extraction from tea leaves and drying is used as a raw material for catechins, the concentration of the catechins in the catechin preparation is only about from 30 to 40%. The preparation therefore needs to be blended in an amount several times higher than the required amount of catechins incorporation.

The present inventor found that in the baking process during the production of a cereal food, the content of catechins decreases due to the exposure of the catechins to high temperature and high pressure, even though a large amount of a catechin preparation is kneaded into a dough.

On the other hand, this heat history can be avoided by using a method in which a formed cereal food is coated with a saccharide solution containing catechins. Here, in the cereal food containing powdered green tea of the above-mentioned prior art, the powdered green tea is mixed with a saccharide liquid and attached to the surface of the cereal food. However, blending in powdered green tea in this commercial product is for imparting powdered green tea flavor, and is not for incorporating a large amount of catechins, and thus the content of the powdered green tea is quite small. The present inventor attempted to incorporate catechins in an amount effective to exert physiological effects, by blending powdered green tea in a saccharide solution and coating a cereal food using this solution. But, it was necessary to blend the powdered green tea in the saccharide solution in an amount ten times higher than the amount of catechins effective to exert physiological effects. As a result, the saccharide solution became a suspension of increased viscosity that had a liquid property difficult to coat onto the cereal food. Furthermore, it was also ascertained that the balance between the saccharide solution for coating and the main body of the cereal food was degraded. Furthermore, it was also found that, since the powdered green tea was difficult to dissolve in the saccharide solution, the appearance was deteriorated when coated with this suspension liquid.

As mentioned above, it was ascertained that there were problems in directly applying a conventional means of producing a frosted cereal food using powdered green tea to a production of a catechins-rich frosted cereal food.

The present invention is contemplated for providing a frosted cereal food with fine appearance despite containing a large amount of catechins.

The present inventor studied various contents of a catechin preparation in a coating material for a frosted cereal food. As a result, it was found that the appearance of the frosted cereal food deteriorates with increasing solid content other than saccharides relative to the saccharides in the coating material, whereas the appearance resists deterioration when the ratio of non-polymer catechins in the solid content other than saccharides is increased. The present invention has been completed based on these findings.

The present invention relates to a frosted cereal food containing catechins in an amount of 0.1 mass % or more with respect to the dry mass of the frosted cereal food, wherein the frosted cereal food includes a coating material containing a solid content other than saccharides in an amount of 1% or more, and the solid content other than saccharides contains the catechins in an amount of 40% or more.

Furthermore, the present invention relates to a method for producing the frosted cereal food, including coating a cereal food with a saccharide solution containing a purified preparation of a catechins-containing plant extract after forming the cereal food,

wherein catechins amount to 40 mass % or more of the solid content of the purified preparation of a catechins-containing plant extract.

The frosted cereal food of the present invention maintains a fine appearance as a cereal food, despite containing a large amount of catechins in the coating material.

Furthermore, according to the production method of the present invention, a large amount of catechins can be incorporated in the cereal food, because decrease or the like of the catechins due to high temperature does not occur in the process of forming of the cereal food.

Other and further features and advantages of the invention will appear more fully from the following description.

### DETAILED DESCRIPTION OF THE INVENTION

In the present invention, the cereal food means a food that is generally referred to as a breakfast cereal (Ready to eat, Breakfast cereal) and is a food containing cereal grains formed by processing a food grain raw material obtained from food grains such as corn, rice, brown rice, wheat, barley, rye, oat, buckwheat, millet and Japanese millet by pressing, forming, swelling, baking and the like, and is generally eaten after adding a liquid food such as milk, or further after heating. Meanwhile, “baked confectionary” is present as similar foods in that they use a food grain as a raw material, but they are different from cereal foods in product category in that they are directly eaten, and they are not served as meals.

The frosted cereal food of the present invention means a cereal food coated with a material containing saccharides as a main component. In the present invention, this coated material is referred to as a coating material for the frosted cereal food. The term “frosted” is derived from the fact that the saccharides are crystallized on the surface of the cereal food, and as a result of this, the saccharides looks like a frost. The frosted cereal food is included in cereal foods.

In the present invention, the term “catechins” means non-polymer catechins, and is a collective term for the collection of non-epi-form catechins such as catechin, gallocatechin, catechin gallate and gallocatechin gallate (GCg); and epi-form catechins such as epicatechin, epigallocatechin, epicatechin gallate and epigallocatechin gallate (EGCg).

In the present invention, catechin gallate, gallocatechin gallate, epicatechin gallate and epigallocatechin gallate are collectively referred to as non-polymer catechin gallate forms. The purified catechin preparation mentioned below, which is used in the present invention, preferably contains epigallocatechin gallate and/or an isomer thereof, and epicatechin gallate and/or an isomer thereof. The gallate form ratio in the catechins is a numerical value that is represented by the percentage of the total mass of these four kinds with respect to the total mass of the eight kinds of non-polymer catechins. Furthermore, the isomer of epigallocatechin gallate in the present invention is gallocatechin gallate, and the isomer of epicatechin gallate is catechin gallate.

In the present invention, the amounts of the catechins in the frosted cereal food is 0.1% or more with respect to the dry mass of the frosted cereal food (i.e., 0.1% or more in the dried product of the frosted cereal food), and is preferably from 0.2 to 10%, more preferably 0.21 to 5%, more preferably 0.25 to 2%, and more preferably 0.3 to 1.7%, from the viewpoint of physiological effects. The dry mass of the frosted cereal food means the mass of the frosted cereal food after the frosted cereal food is heated for 2 hours in a thermostat desiccator set to 105° C. and cooled in the desiccator until the temperature returns to room temperature. The catechins are preferably present in the coating material of the frosted cereal food.

In the frosted cereal food of the present invention, a solid content other than saccharides amounts to 1% or more of the coating material, and the catechins amount to 40% or more of the solid content other than saccharides. It is preferable that the solid content other than saccharides amounts to, preferably from 1 to 25%, more preferably from 5 to 15%, more preferably from 7 to 13% of the coating material, from the viewpoints that the saccharides are crystallized uniformly to give a fine frost form, and that a cereal food containing catechins in an amount necessary to exert physiological functions can be stably obtained. It is preferable that the catechins amount to, preferably from 45 to 80%, more preferably from 50 to 75%, and more preferably from 60 to 70% of the solid content other than saccharides in the coating material, from similar viewpoints.

In order to form the frosted cereal food of the present invention, it is preferable to use a purified preparation of a catechins-containing plant extract (hereinafter referred to as “purified catechin preparation”), and to coat the cereal food with a mixture of the purified catechin preparation and a saccharide solution (a saccharide solution containing the purified preparation of a catechins-containing plant extract), so as to incorporate the catechins. The purified catechin preparation is obtained by further purifying an extract obtained from a catechins-containing plant, and contains substances that are referred to as tannin that contains catechins, as well as polymerized products or hydrolysates thereof, and other flavonoids. It is preferable that the amount of tannin in the solid content of the purified catechin preparation is preferably 40% or more, more preferably from 40 to 99%, more preferably from 45 to 80%, more preferably from 50 to 70%, from the viewpoint that the amount of catechins required to exert physiological functions can be stably incorporated in the cereal. Furthermore, it is preferable that the amount of the catechins in the solid content of the purified catechin preparation is preferably 35% or more, more preferably 40% or more, more preferably from 40 to 90%, and more preferably from 45 to 80%, from the viewpoint that the amount of catechins required to exert physiological functions can be stably incorporated in the frosted cereal food.

In the present invention, the amount of catechins can be measured with high performance liquid chromatography under the conditions described in Examples, and the amount of tannin can be measured by an iron tartrate method under the conditions described in Examples by using ethyl gallate as a standard solution and based on the equivalent amount of gallic acid.

The purified catechin preparation used in the present invention is a solid, a powder form or a liquid form. In the embodiments of the present invention, it is preferable that the purified catechin preparation has a turbidity of 40 FTU (formazin turbidity unit) or less, more preferably 35 FTU (formazin) or less, more preferably 25 FTU (formazin) or less at an aqueous solution of 0.5% solid content, from the viewpoints that the saccharides are uniformly crystallized to give a fine frost form when they are mixed with the saccharide solution and subjected to coating, a frosted cereal food containing the catechins in an amount required to exert physiological functions can be stably obtained, and the saccharide solution has a low viscosity and thus gives fine ejection property and coating property.

Furthermore, it is preferable that the purified catechin preparation has an absorbance at 671.5 nm of 0.4 or less, more preferably 0.35 or less, more preferably 0.25 or less at an aqueous solution of 1.0% solid content, using a cell having an optical path length of 10 mm, from the viewpoints that the saccharides are uniformly crystallized to give a fine frost form, a frosted cereal food containing the catechins in an amount required to exert physiological functions can be stably obtained, and a mixed solution with the saccharide solution has a low viscosity and thus gives fine ejection property and coating property.

Furthermore, it is preferable that the purified catechin preparation has a viscosity obtained with a type B viscometer at a temperature of 20° C. of preferably 160 mP·s or less, more preferably from 5 to 70 mPa·s, more preferably from 10 to 50 mPa·s at an aqueous solution of 40% solid content, from the viewpoints that a frosted cereal food containing the catechins in an amount required to exert physiological functions can be stably obtained, and a mixed solution with the saccharide solution has a low viscosity and thus gives fine ejection property and coating property.

It is preferable that the purified catechin preparation contains (A) myricetin, (B) quercetin and (C) kaempferol in the sum of their contents (the content of (A)+(B)+(C)) of from 0.000001 to 5%, more preferably from 0.00001 to 3%, more preferably from 0.001 to 1.8%, from the viewpoints that the saccharides are uniformly crystallized to give a fine frost form when mixed with the saccharide solution followed by coating, and the mixed solution with the saccharide solution has a low viscosity and thus gives fine ejection property and coating property.

Furthermore, it is preferable that the purified catechin preparation contains (D) epigallocatechin gallate and (E) gallocatechin gallate in the sum of their contents (the content of (D)+(E)) of from 15 to 95%, more preferably from 18 to 40%, more preferably from 20 to 35%, from the viewpoints that the saccharides are uniformly crystallized to give a fine frost form when mixed with the saccharide solution, followed by coating, and the mixed solution with the saccharide solution has a low viscosity and thus gives fine ejection property and coating property.

Furthermore, it is preferable that the ratio of the sum of the contents of (A) myricetin, (B) quercetin and (C) kaempferol to the sum of the contents of (D) epigallocatechin gallate and (E) gallocatechin gallate (the content of (A)+(B)+(C)/the content of (D)+(E)) is from 0.0001 to 0.1 (mass ratio), from the viewpoints that the saccharides are uniformly crystallized to give a fine frost form when mixed with the saccharide solution, followed by coating, and the mixed solution with the saccharide solution has a low viscosity and thus gives fine ejection property and coating property. Furthermore, it is more preferable that the above ratio is from 0.001 to 0.09, and specifically from 0.01 to 0.09. The contents of the components (A), (B), (C), (D) and (E) can be measured with high performance liquid chromatography under the conditions described in Examples, after the hydrolysis of the purified catechin preparation.

It is preferable that the frosted cereal food of the present invention contains the components (A), (B), (C), (D) and (E), and the ratio of the sum of the contents of (A), (B) and (C) to the sum of the contents of (D) and (E) (the content of (A)+(B)+(C)/the content of (D)+(E)) is from 0.0001 to 0.1 (mass ratio), more preferably from 0.001 to 0.09, more preferably from 0.01 to 0.09, from the viewpoint of keeping the appearance of the cereal food despite containing a large amount of catechins. The ratio can be obtained by coating the cereal food with the saccharide solution containing the above-mentioned purified preparation of a catechins-containing plant extract.

Furthermore, it is preferable that the above-mentioned purified catechin preparation contains (F) rutin in an amount of from 0.0001 to 2%, more preferably from 0.001 to 1.2%, and more preferably from 0.01 to 1.0%, from the viewpoints that the saccharides are uniformly crystallized to give a fine frost form when mixed with the saccharide solution, followed by coating, and the mixed solution with the saccharide solution has a low viscosity and thus gives fine ejection property and coating property. The content of the component (F) can be measured with high performance liquid chromatography under the conditions described in Examples. Rutin is one of flavonol glycosides, in which β-rutinose (6-O-α-L-rhamnosyl-D-β-glucose) is bound to the oxygen atom at the 3-position of quercetin.

It is preferable that the purified catechin preparation contains caffeine in an amount of from 0.0001 to 10%, more preferably from 0.001 to 7%, more preferably from 0.01 to 5%, from the viewpoint of reduction of frequent urination, insomnia and the like which are caused by caffeine. The content of the caffeine can be measured with high performance liquid chromatography under the conditions described in Examples.

The above-mentioned purified catechin preparation may be one obtained by purifying a catechins-containing plant extract (hereinafter simply referred to as “plant extract”), and examples of the plant may include teas, grapes, apples, soybeans and the like. The teas include processed tea leaves such as green tea, oolong tea and black tea. Among them, green tea is specifically preferable. Here, for example, an extract from green tea refers to as “a green tea extract”.

Examples of the green tea extract may include a liquid extract obtained from green tea leaves. More specific examples of the above-mentioned processed tea leaves may include processed tea leaves obtained from Camellia such as C. sinensis, C. assamica, Yabukita species, hybrids thereof, and the like. Examples of the above-mentioned green tea may include ordinary tea (sencha), coarse tea (bancha), highest-quality tea (gyokuro), powdered green tea (tencha), roasted tea (kamairicha) and the like. Alternatively, tea leaves contacted with carbon dioxide in a supercritical state may also be used. As a means of obtaining an extract of tea, conventional methods such as extraction under stirring, a column method and drip extraction can be employed. Furthermore, an organic acid or an organic acid salt such as sodium ascorbate may be added in advance to the water for the extraction. Furthermore, a method of extracting under what is called a non-oxidative atmosphere while removing dissolved oxygen by deaeration by boiling or passing inert gas such as nitrogen gas may be employed in combination. A liquid extract obtained by these methods can be used directly or after drying and concentrating for the preparation of the purified catechin preparation used in the present invention. Examples of the form of the tea extract may include states of liquid, slurry, semi-solid and solid.

As the green tea extract, besides the liquid extract extracted from tea leaves, a concentrate of the green tea extract which is dissolved or diluted in water or an organic solvent may be used, or the liquid extract extracted from tea leaves and the concentrate of the green tea extract may be used in combination.

As used herein, the concentrate of the green tea extract is obtained by concentrating an extract extracted from green tea leaves with hot water or a water-soluble organic solvent, and for example, refers to those prepared by the methods described in JP-A-59-219384, JP-A-4-20589, JP-A-5-260907, JP-A-5-306279 and the like. Specifically, commercially available crude catechin preparations such as “POLYPHENONE” manufactured by Mitsui Norin Co., Ltd., “TEAFURAN” manufactured by Ito En, Ltd., “SUNPHENON” manufactured by Taiyo Kagaku Co., Ltd., and the like can be used as a solid concentrate of the green tea extract.

Furthermore, for the catechins-containing plant extracts other than the green tea extracts, those extracted by general means can be used.

The above-mentioned purified catechin preparation can be prepared by contacting the plant extract such as the green tea extract directly or in a state that the extract is dispersed or dissolved in water or an organic solvent aqueous solution, with an active carbon, an acid clay and/or an active clay (hereinafter also referred to as “acid clay or the like”), a filtration aid or the like.

The order of contacting the plant extract with the active carbon, the acid clay or the like, and optionally the filtration aid or the like is not specifically limited. Examples may include (1) a method in which the plant extract is dispersed or dissolved in water or an organic solvent aqueous solution, followed by adding simultaneously the active carbon, the acid clay or the like and optionally the filtration aid or the like thereto to allow contact, (2) a method in which the active carbon, the acid clay or the like and optionally the filtration aid or the like are dispersed in water or an organic solvent aqueous solution, followed by adding the plant extract thereto to allow contact, (3) a method in which the plant extract, the acid clay or the like and optionally the filtration aid or the like dissolved or dispersed in water or an organic solvent aqueous solution to contact the plant extract with the acid clay and the like and optionally the filtration aid or the like in advance, followed by adding the active carbon thereto. Among the methods of (1) to (3), the method of (1) or (3) is preferable. In the methods of (1) to (3), it is preferable to insert a filtration step before transferring to the subsequent step.

In the contact treatment, it is preferable to conduct the treatment after adjusting the pH to the range of from 4 to 6 so as to obtain a purified catechin preparation in which non-polymer catechins have been extracted efficiently. In order to adjust the pH, an organic acid such as citric acid, lactic acid, tartaric acid, succinic acid and malic acid can be added so that the range of a mass ratio of the organic acid to the non-polymer catechins (organic acid/non-polymer catechins) be from 0.01 to 0.20.

The contact treatment may be conducted by any of a batch-type method, a continuous treatment by columns, and the like, and for example, contacting the plant extract with an active carbon can be conducted by a method such as a continuous treatment with active carbon columns. In general, a method in which powdery active carbon and the like are added, followed by stirring to selectively adsorb impurities and a filtrate from which the impurities have been removed by filtration treatment is obtained, a method in which impurities are adsorbed by a continuous treatment using columns filled with granular active carbon or the like, or the like is employed.

As the organic solvent used for the purification of the plant extract, a water-soluble organic solvent is preferable, and examples may include alcohols such as methanol and ethanol, ketones such as acetone, and esters such as ethyl acetate, and ethanol is specifically preferable with consideration for use in beverage and food products. Examples of the water may include ion exchanged water, tap water, natural water and the like, and ion exchanged water is specifically preferable from the viewpoint of taste.

The mixing mass ratio of the organic solvent with respect to water (organic solvent/water) is preferably from 60/40 to 97/3, more preferably from 60/40 to 75/25, more preferably from 85/15 to 95/5, from the viewpoints of the extraction efficiency of the non-polymer catechins, the purification efficiency of the plant extract, and the like.

For the ratio of the plant extract with respect to the water or the organic solvent aqueous solution, it is preferable to treat by adding from 10 to 40 parts by mass (hereinafter simply referred to as “parts”), more preferably from 10 to 30 parts, more preferably from 15 to 30 parts of the plant extract (dried mass basis) with respect to 100 parts of the water or the organic solvent aqueous solution, since the plant extract can be treated efficiently.

It is preferable to provide an aging time of from about 10 to about 180 minutes to the contact treatment, and these treatments can be conducted at from 10 to 60° C., and are preferably conducted at specifically from 10 to 50° C., more preferably from 10 to 40° C.

The active carbon used in the contact treatment is not specifically limited as long as it is generally used in an industrial level, and for example, commercially available products such as ZN-50 (manufactured by Hokuetsu Carbon Industry Co., Ltd.), KURARAYCOAL GLC, KURARAYCOAL PK-D and KURARAYCOAL PW-D (manufactured by Kuraray Chemical Co., Ltd.) and SHIRASAGI AW50, SHIRASAGI A, SHIRASAGI M and SHIRASAGI C (manufactured by Takeda Pharmaceutical Co., Ltd.) can be used.

The active carbon preferably has a pore volume of from 0.01 to 0.8 mL/g, more preferably from 0.1 to 0.8 mL/g. Furthermore, one having a specific surface area of from 800 to 1,600 m²/g is preferable, and from 900 to 1,500 m²/g is more preferable. These material values are values based on a nitrogen adsorption method.

It is preferable to add the active carbon in an amount of from 0.5 to 8 parts, more preferably from 0.5 to 3 parts, with respect to 100 parts of the water or the organic solvent aqueous solution, from the viewpoints of the efficiency of removal of impurities, and a small cake resistance in the filtration step.

Both of the acid clay and the active clay used in the contact treatment contains SiO₂, Al₂O₃, Fe₂O₃, CaO, MgO and the like as general chemical components, and those having an SiO₂/Al₂O₃ ratio of from 3 to 12 by a molar ratio are preferable, and more preferably from 4 to 9 by a molar ratio are more preferable. Furthermore, those containing Fe₂O₃ in an amount of from 2 to 5%, CaO in an amount of from 0 to 1.5% and MgO in an amount of from 1 to 7% are preferable.

Active clay is obtained by treating naturally-produced acid clay (montmorillonite-based clay) with a mineral acid such as sulfuric acid, and is a compound having a porous structure having a large specific surface area and adsorption ability. It is known that a specific surface area is changed, decoloration ability is improved and physical properties are changed by further treating acid clay with an acid.

Although the specific surface area of the acid clay or the active clay differs depending on the degree of the acid treatment and the like, it is preferably from 50 to 350 m²/g, and one having a pH (5% suspension) of from 2.5 to 8 is preferable and from 3.6 to 7 is more preferable. For example, as the acid clay, commercially available products such as MIZUKA ACE #600 (trade name, manufactured by Mizusawa Industrial Chemicals, Ltd.) can be used. Furthermore, as the active clay, commercially available products such as GALLEON EARTH V2 (trade name, manufactured by Mizusawa Industrial Chemicals, Ltd.) can be used.

Furthermore, the ratio of the active carbon to the acid clay and the like is preferably from 1 to 10 of the acid clay and the like with respect to 1 of the active carbon by mass ratio, and it is preferable that active carbon:acidic white clay and/or active white clay=1:1 to 1:6.

It is preferable to add the acid clay and the like in an amount of from 2.5 to 25 parts, more preferably from 2.5 to 15 parts with respect to 100 parts of the water or the organic solvent aqueous solution. If the addition amount of the acid clay and the like is too small, the caffeine removal efficiency tends to decrease, whereas when the addition amount is too much, the cake resistance in the filtration step tends to increase.

The filtration aid used for the contact treatment is not specifically limited as long as it is a filtration aid that is generally used at an industrial level such as diatomaceous earth, and for example, commercially available products such as SOLKA-FLOC (trade name, manufactured by Imazu Chemical Co., Ltd.) and SILICA 100F-A (trade name, manufactured by Chuo Silica Co., Ltd.) can be used.

The temperature at which the active carbon and the like are separated from the water or organic solvent aqueous solution is preferably from −15 to 78° C., more preferably from 5 to 40° C. If the temperature is out of this range, the separation property may be poor, and a change may be observed in the characteristic of the solution.

As a method for separation, a known technique can be employed, and for example, techniques such as filter separation and centrifuge, as well as separation by passing through a column filled with a granular substance such as an active carbon and the like may be used.

Furthermore, a synthetic adsorbent can be used upon the preparation of the purified catechin preparation. In general, the synthetic adsorbent is preferably an insoluble three-dimensional crosslinked structure polymer that is substantially free from functional groups such as an ion exchanging group. Preferably, one having an ion-exchanging ability of less than 1 meq/g can be used. As the synthetic adsorbent used in the present invention, those having a styrene-base as a matrix therefor such as AMBERLITE XAD4, XAD16HP, XAD1180 and XAD2000 (supplier: U.S. Rohm & Haas Company), DIAION HP20 and HP21 (manufactured by Mitsubishi Chemical Corporation), SEPABEADS SP850, SP825, SP700 and SP70 (manufactured by Mitsubishi Chemical Corporation), VPOC1062 (manufactured by Bayer); modified styrene-bases in which the adsorbability is enhanced by the nucleus substitution of a bromine atom such as SEPABEADS SP205, SP206 and SP207 (manufactured by Mitsubishi Chemical Corporation); methacrylic-bases such as DIAION HP1 MG and HP2MG (manufactured by Mitsubishi Chemical Corporation); phenol-bases such as AMBERLITE XAD761 (manufactured by Rohm & Haas Company); acrylic-bases such as AMBERLITE XAD7HP (manufactured by Rohm & Haas Company); polyvinyl-bases such as TOYOPEARL, HW-40C (manufactured by Tosoh Corporation); dextran-bases such as SEPHADEX, LH-20 (manufactured by Pharmacia Corporation), and the like (all are trade names) can be used.

As the synthetic adsorbents, those having a styrene-base, a methacrylic-base, an acrylic-base and a polyvinyl-base as the matrices therefor are preferable, and a styrene-base is preferable from the viewpoint of the separation property of catechin from caffeine.

As a means for adsorbing the plant extract to the synthetic adsorbent, a batch method in which the synthetic adsorbent is added to the plant extract and adsorbed by stirring, and the synthetic adsorbent is then collected by a filtration operation, or a column method in which an adsorption treatment is conducted by continuous treatments using columns filled with the synthetic adsorbent is employed, and the continuous treatment using columns is preferable from the viewpoint of producibility. It is preferable that the usage amount of the synthetic adsorbent is preferably 10 vol %, more preferably 15 vol %, specifically preferably 20 vol % with respect to the plant extract, from the viewpoints of the adsorption efficiency of the non-polymer catechins, and the like.

It is preferable to wash the columns filled with the synthetic adsorbent in advance with a 95 vol % ethanol aqueous solution under liquid feeding conditions of SV (space velocity)=0.5 to 10 [h⁻¹] and a liquid feeding factor with respect to the synthetic adsorbent of from 2 to 10 [v/v] to remove the raw material monomer, other impurities and the like from the synthetic adsorbent. Thereafter, the adsorption ability of the non-polymer catechins is improved by a method in which washing with water is conducted under liquid feeding conditions of SV=0.5 to 10 [h⁻¹] and a liquid feeding factor with respect to the synthetic adsorbent of from 1 to 60 [v/v], and thus ethanol is removed by substituting the liquid containing the synthetic adsorbent with an aqueous system.

As the condition for liquid feeding of the plant extract to the columns, when the extract is adsorbed on the synthetic adsorbent, it is preferable that the concentration of the non-polymer catechins in the plant extract is preferably from 0.1 to 22%, more preferably from 0.1 to 15%, more preferably from 0.5 to 10%, and more preferably from 0.5 to 3%, from the viewpoint of an efficiency of absorption to a resin.

As the conditions for the liquid feeding of the plant extract to the columns filled with the synthetic adsorbent, it is preferable to conduct liquid feeding at a liquid feeding velocity of SV (space velocity)=0.5 to 10 [h⁻¹] and a liquid feeding factor with respect to the synthetic adsorbent of 0.5 to 20 [v/v]. If the liquid feeding velocity is 10 [h⁻¹] or less, or the liquid feeding amount is 20 [v/v] or less, the adsorption of the non-polymer catechins is sufficient.

After adsorbing the plant extract, it is preferable that the synthetic adsorbent is washed with water or an organic solvent aqueous solution. The aqueous solution used for the washing of the synthetic adsorbent is preferably water of pH 7 or less from the viewpoint of the collection ratio of the non-polymer catechins, and can also be used in a mixed system with a water-soluble organic solvent. Examples of the water-soluble organic solvent may include acetone, methanol, ethanol and the like, and ethanol is preferable from the viewpoint of use in beverage and food products. It is preferable that the concentration of the organic solvent as included is from 0 to 20%, more preferably from 0 to 10% and more preferably from 0 to 5%, from the viewpoint of the collection ratio of the non-polymer catechins.

In this washing step, it is preferable to remove the impurities attached to the synthetic adsorbent at a liquid feeding velocity of SV (space velocity)=0.5 to 10 [h⁻¹] and a liquid feeding factor with respect to the synthetic adsorbent of 1 to 10 [v/v]. Furthermore, it is preferable to wash at a liquid feeding velocity of SV=0.5 to 5 [h⁻¹] and a liquid feeding factor with respect to the synthetic adsorbent of 1 to 5 [v/v], from the viewpoints of an effect of removing foreign substances and the collection ratio of the non-polymer catechins.

Subsequently, the non-polymer catechins are eluted, and an organic solvent aqueous solution or a basic aqueous solution is preferable as an eluant.

As the organic solvent aqueous solution, a mixed system of a water-soluble organic solvent and water is used, and examples of the water-soluble aqueous solution may include acetone, methanol, ethanol and the like. Among these, ethanol is preferable from the viewpoint of use in beverage and food products. It is preferable that the concentration of the water-soluble organic solvent is from 20 to 70%, more preferably from 30 to 60%, more preferably from 30 to 50%, from the viewpoint of the collection ratio of the non-polymer catechins.

As the basic aqueous solution used for the elution of the non-polymer catechins, alkali aqueous solutions of alkali metal salts or alkaline earths, preferably sodium-based alkaline aqueous solutions such as an aqueous solution of sodium hydroxide and an aqueous solution of sodium carbonate can be preferably used. The alkali aqueous solution preferably has a pH in the range of from 7 to 14. It is preferable that the pH is from 9 to 14, more preferably from 10 to 13.5, in view of the collection ratio of the non-polymer catechins. Examples of the sodium-based aqueous solutions having a pH of from 7 to 14 may include an aqueous solution of 4% or less of sodium hydroxide, an aqueous solution of 1N-sodium carbonate and the like. The water-soluble organic solvent can be mixed with the basic aqueous solution. The concentration of the organic solvent is preferably in the range of from 0 to 90%, more preferably from 0 to 50%, and more preferably from 0 to 20%, from the viewpoint of the separation property of caffeine from catechin.

In the elution step, two or more kinds of basic aqueous solutions having different pHs from each other can be used as basic aqueous solutions for use in the elution, and these basic aqueous solutions can be contacted with the synthetic adsorbent in the ascending order of pHs. Different non-polymer catechins and other components can be desorbed in the respective pH compartments.

It is preferable to elute the non-polymer catechins at a liquid feeding velocity of SV (space velocity)=2 to 10 [h⁻¹] and a liquid feeding factor with respect to the synthetic adsorbent of 1 to 30 [v/v]. Furthermore, it is preferable to elute at a liquid feeding velocity of SV=3 to 7 [h⁻¹] and a liquid feeding factor of 3 to 15 [v/v], from the viewpoints of producibility and the collection ratio of the non-polymer catechins.

The synthetic adsorbent can be reused by using a predetermined method after the purification treatment. Specifically, an organic solvent such as ethanol is fed to desorb unnecessary components such as caffeine which are adsorbed on the synthetic adsorbent. Alternatively, all of the water-soluble components remaining on the synthetic adsorbent can be desorbed by washing by feeding an alkali aqueous solution such as sodium hydroxide. In addition, washing with water vapor may be combined.

Although the eluate obtained by eluting the non-polymer catechins with the basic solution is basic, it is generally preferable to adjust the pH of the eluate to 7 or less, more preferable to from 1 to 6, more preferable to from 1 to 5, and more preferable to from 2 to 4, from the viewpoint of the stability of the non-polymer catechins. Specifically, neutralization with an acid, removal of alkali metal ions by electrodialysis, or removal of alkali metal ions by an ion-exchanging resin can be utilized. As the ion-exchanging resin, use of an H-type cation-exchanging resin is preferable. For the convenience of the processes, it is preferable to adjust the pH with an ion-exchanging resin. Specifically, as the cation-exchanging resin, AMBERLITE 200CT, IR120B, IR124 and IR118 (supplier: U.S. Rohm & Haas Company), DIAION SK1B, SK1BH, SK102, PK208 and PK212 (manufactured by Mitsubishi Chemical Corporation) and the like can be used.

It is preferable to concentrate the eluate of the non-polymer catechins to remove the precipitate by solid-liquid separation for improving the taste and stability. The concentration can be conducted by distillation under a reduced pressure, thin film distillation, membrane concentration or the like. The concentration rate is preferably from 2 to 500 times, more preferably from 2 to 250 times, more preferably from 2 to 125 times, from the viewpoints of the taste and the separation property of the precipitate. The concentration of the non-polymer catechins after the concentration is preferably from 0.1 to 70%, more preferably from 0.2 to 50%, more preferably from 0.5 to 25%, from the viewpoints of the taste and the separation property of the precipitate. Specific operations for solid-liquid separation may include filtration and/or a centrifugation treatment, and the like.

As a means of the solid-liquid separation, methods that can be used in the food industry can be applied. For example, the condition for membrane filtration when solid-liquid separation is conducted by membrane filtration includes a temperature of preferably from 5 to 70° C., more preferably from 10 to 40° C. The membrane pore size is preferably from 0.1 to 10 μm from the viewpoint that a predetermined turbidity is provided, and is more preferably from 0.1 to 5 μm, and more preferably from 0.1 to 2 μm from the viewpoints of the time required for the filtration and the separation property of the turbid component. The method for measuring the membrane pore size may include general measurement methods using a mercury press-in method, a bubble point test, a bacteria filtration method and the like, and it is preferable to use a value obtained by a bubble point test. As the material for the membrane used in membrane filtration, a polymer membrane, a ceramic membrane, a stainless membrane and the like can be used.

Furthermore, the centrifugal machine is preferably a general device such as a separation plate type, a cylindrical type, a decanter type or the like. As the conditions for centrifugation, the temperature is preferably from 5 to 70° C., more preferably from 10 to 40° C., and the number of rotation and time are preferably conditions that are adjusted so as to give a predetermined turbidity. For example, in the case of a separation plate type, it is preferable from 3,000 to 10,000 rpm, more preferable from 5,000 to 10,000 rpm, more preferable from 6,000 to 10,000 rpm, and it is preferable from 0.2 to 30 min, more preferable from 0.2 to 20 min, more preferable from 0.2 to 15 min.

Furthermore, from the viewpoint of stabilization of the color tone, it is preferable to decolor the eluate of the non-polymer catechins. As specific operations for decoloration, the purified catechin preparation can be decolored by contacting the purified catechin preparation, directly or after dispersing or dissolving in water or an organic solvent aqueous solution, with at least one kind selected from an active carbon, an active clay and acid clay.

In the case when further lowering of bitter taste is desired, the plant extract can be treated with an enzyme having a tannase activity. From the viewpoint of taste, it is preferable to conduct an enzyme treatment before adsorbing on the synthetic adsorbent. Among those, a tannase is preferable. Examples may include tannases obtained by culturing tannase-producing bacteria belonging to genus Aspergillus, genus Penicillium and genus Rhizopus. Among these, one derived from Aspergillus oryzae is preferable.

Specifically, as the enzyme having a tannase activity, commercially available products such as PECTINASE PL AMANO (manufactured by Amano Enzyme, Inc.), HEMICELLULASE AMANO 90 (manufactured by Amano Enzyme, Inc.) and TANNASE KTFH (manufactured by Kikkoman Corporation) (all are trade names) can be used. It is preferable to conduct a treatment with an enzyme having a tannase activity, i.e., an enzyme reaction, which is conducted in the present invention, with tannin acyl hydrase EC3.1.1.20 or the like. Examples of commercially available products may include a trade name “TANNASE” (manufactured by Kikkoman Corporation) tannase “SANKYO” (manufactured by Sankyo Co., Ltd.) and the like.

It is preferable that the enzyme having a tannase activity has an enzyme activity of from 500 to 100,000 U/g, and when the enzyme activity is 500 U/g or less, a large amount of enzyme is required for treating within an industrially-limited time, whereas when the enzyme activity is 100,000 U/g or more, the enzyme reaction velocity is too fast and thus it becomes difficult to control the reaction system. Here, 1 Unit represents the amount of the enzyme at which 1 micromole of ester bonds included in tanninc acid is hydrolyzed in water at 30° C. Here, having a tannase activity means having an activity to decompose tannin, and any enzyme can be used as long as it has this activity.

The concentration of the non-polymer catechins for a treatment with the enzyme having a tannase activity is preferably from 0.1 to 22%, more preferably from 0.1 to 15%, more preferably from 0.5 to 10%, and more preferably from 0.5 to 3%.

The enzyme having a tannase activity is added so as to be preferably from 1 to 300 Unit, more preferably from 3 to 200 Unit, more preferably from 5 to 150 Unit with respect to 1 g of the non-polymer catechins in the plant extract.

The temperature of the enzyme treatment is preferably from 0 to 70° C. at which an optimal enzyme activity can be obtained, and is more preferably from 0 to 60° C., and more preferably from 5 to 50° C.

In order to terminate the enzyme reaction, the enzyme activity is deactivated. The temperature for the enzyme deactivation is preferably from 70 to 100° C., and the retention time therefor is preferably from 10 seconds to 20 minutes. If the deactivation temperature is too low, it is difficult to sufficiently deactivate the enzyme within a short time, and thus the reaction proceeds and the enzyme reaction cannot be stopped within a required range of the gallate form ratio of the non-polymer catechins. Furthermore, if the retention time after attaining a deactivation temperature is too short, it is difficult to sufficiently deactivate the enzyme activity, and thus the enzyme reaction proceeds. Whereas a too long retention time is not preferable since non-epimerization of the non-polymer catechins may occur.

As the means of deactivating the enzyme reaction, the reaction can be stopped by heating in a continuous manner such as a batch-type or plate-type heat exchanger. Furthermore, after the completion of the deactivation of the tannase treatment, the plant extract can be cleaned by an operation such as centrifugation.

It is preferable to blend the obtained purified catechin preparation into the frosted cereal food by coating cereal food with a saccharide solution containing the purified catechin preparation using techniques such as ejecting the saccharide solution containing the purified catechin preparation to the formed cereal food, or soaking the cereal food in the saccharide solution containing the purified catechin preparation, from the viewpoint that the decreasing of the content of the catechins caused by heat exposure in the steaming step, baking step or the like can be prevented. Here, the forming of the cereal food includes steps of steaming, cooling, pressing, forming, swelling, drying and baking of a food grain raw material, and it is more preferable to add the purified catechin preparation after completion of the baking step from the above-mentioned viewpoints. Alternatively, a part of the catechin preparation such as the purified catechin preparation may be blended into the main body of the cereal in advance.

When a coating treatment is conducted, the surface of the formed cereal food may be coated by using a general ejection device, after dissolving or dispersing the purified catechin preparation in water, blending the saccharides therein, and dissolving the saccharides by stirring in a warming device, or after dissolving the purified catechin preparation in a solution in which saccharides has been dissolved by warming. Alternatively, it is also possible to spray a solution containing the saccharides and/or a thickening agent on the formed cereal food once, and further attach thereto the purified catechin preparation in the form of a powder or granules and a solution containing saccharides. Examples of specific coating treatments may include a conveyor belt system in which ejection is conducted on the cereal food mounted on a conveyor belt, a rotation drum system in which ejection is conducted on the cereal food that transfers in a rotation drum, and the like. Here, it is preferable to adjust the concentration of the catechins in the saccharide solution containing the purified catechin preparation to from 0.01 to 15%, more preferably from 0.5 to 11%, and more preferably from 0.6 to 9%, from the viewpoint of easiness of drying after the coating, and from the viewpoint that a large amount of catechins are incorporated in the frosted cereal food, and that the saccharides are crystallized uniformly to give a fine frost form. Furthermore, the amount of the solid content other than saccharides in the solid content of the saccharide solution containing the purified catechin preparation is preferably 1% or more, more preferably from 1 to 25%, more preferably from 5 to 15% and more preferably from 7 to 13%. Furthermore, catechins amount to preferably 40% or more, more preferably from 45 to 80%, more preferably from 50 to 75%, and more preferably from 60 to 70% of the solid content other than saccharides. It is preferable to adjust the concentration of the saccharides in the saccharide solution containing the purified catechin preparation to from 60 to 86%, more preferably from 70 to 85%, and more preferably from 75 to 84%, from the viewpoint of easiness of drying after the coating.

Furthermore, it is preferable to adjust the amount of the saccharide solution containing the purified catechin preparation to be attached to the formed cereal food so that the solid content of the saccharide solution in the frosted cereal food be from 3 to 70%, more preferably from 5 to 60%, more preferably from 10 to 50%, from the viewpoints of the taste (sweet taste during eating) and texture of the frosted cereal food, and easiness of drying after the coating, and also from the viewpoint that a large amount of catechins are incorporated in the frosted cereal food.

Examples of the form of the saccharides which can be used for coating the cereal food may include granulated sugar, superfine sugar, soft brown sugar, isomerized liquid sugar (glucose-fructose liquid sugar, sugar-mixed isomerized liquid sugar, fructose-glucose liquid sugar), honey, maple sugar, starch syrup and the like.

Furthermore, examples of the substance may include monosaccharides, disaccharides and polysaccharides, and more specific examples may include sucrose, glucose, fructose, maltose, lactose, xylose, ribose, mannose, sorbitol, dextrin, reduced dextrin and the like.

The form of the frosted cereal food in the present invention is not specifically limited, and examples may include flaked cereal, puffed cereal, shredded cereal, extrude expand cereal, granola and granola-like foods, and the like. With regard to the method for producing the frosted cereal food of the present invention, cereal food can be produced according to a production method that is tailored to the form of the above-mentioned cereal food, except incorporating catechins. Namely, in order to produce the cereal food, it is sufficient to conduct steaming, cooling, pressing, forming, swelling, drying and baking and the like of a food grain raw material by conventional means.

The main raw material of the cereal food is various food grains, and there are two forms therefor: cereal grains and a cereal powder. The cereal grains are used directly, or used by mixing with the cereal powder. When the cereal grains and the cereal powder are mixed, or when only the cereal powder are used, they are formed into pellets (extrude pellets) by a cooking extruder.

Examples of the cereal grains as the raw material used in the present invention may include corn, brown rice, wheat, barley, rye, oat, adlay, naked barley, buckwheat, millet, proso mllet, Japanese millet, milo and amaranth. Furthermore, beans such as soybean, red bean, green pea, fava bean and marrow bean are also included.

Although the raw material for the cereal food in the present invention may be only the above-mentioned cereal grains and the like, emulsifiers, binders, saccharides, natural or artificial sweeteners, chocolate, cocoa, dietary salt, seasonings, spices, fats and oils, colorants, dried vegetables, dried fruits, nuts, vitamins, mineral additives, dietary fibers, proteins and the like can be optionally blended. The means of blending in these additives is not specifically limited, and they may be kneaded into a dough or mixed in the above-mentioned saccharide solution, or may be added to the cereal food coated with the above-mentioned saccharide solution.

Examples of the emulsifiers may include glycerin fatty acid esters, sucrose fatty acid esters, sorbitan fatty acid esters and the like. These emulsifiers have a function to prevent corn grains from attaching to each other in the steaming step.

Furthermore, friction is decreased during granulation by an extruder and the grains become difficult to be excessively broken, and attaching of granules to each other can be prevented after the granulation.

As the binders, starch, gums and thickening agents can be used, and it is sufficient to blend these by a small amount.

Examples of the fats and oils may include corn oil, sesame oil, soybean oil, wheat germ oil, palm oil, rapeseed oil, sunflower oil, cottonseed oil and the like.

The saccharides include monosaccharides, disaccharides and polysaccharides such as glucose, fructose, lactose, sucrose, maltose, xylose, ribose, mannose, sorbitol, dextrin, reduced dextrin and the like, and these are used with one kind or combination of two or more kinds. Alternatively, honey, maple sugar, starch syrup and the like can also be used in a similar manner.

As the natural or artificial sweeteners, for example, stevia, a sodium salt or calcium salt of saccharin, cyclamate, aspartame and the like can also be used in combination. The saccharides are used by a ratio of from 10 to 50 parts, preferably from 20 to 40 parts to 100 parts of flakes. This amount can be suitably increased according to the kind of the raw material food grain and the property of a final product to be obtained.

As the dried vegetables, carrot, spinach and the like can be used.

The dried fruits may include apple, raisin, strawberry, papaya and the like. Furthermore, nuts such as almond, pine nut and walnut, as well as cacaos such as cacao mass and cacao butter can be used.

Vitamins such as vitamin A, B-complex vitamins, vitamin C, vitamin D, vitamin E and niacin; minerals such as inorganic iron, heme iron, calcium, potassium, magnesium, zinc, copper, selenium, manganese, cobalt, iodine and phosphorus; dietary fibers such as indigestible dextrin, crystalline cellulose, apple fiber, wheat bran, rice bran, corn bran and wood fibers are used. The proteins may be plant proteins or animal proteins, and among the plant proteins, powders of soybean protein, powders of wheat protein and the like are preferable, and among the animal proteins, meat powder, milk casein and egg white powder are preferably used.

### EXAMPLES

### <Method for Measuring Non-Polymer Catechins>

The measurement of non-polymer catechins was conducted by diluting a catechin preparation (an extract of a catechins-containing plant or a purified preparation thereof) with distilled water and filtered by a filter (pore size: 0.8 μm), and thereafter conducting a gradient method using liquid A and liquid B, by using high performance liquid chromatography manufactured by Shimadzu Corporation (model SCL-10AVP) attaching a packed column for liquid chromatography in which octadecyl groups had been introduced, L-COLUMN TM ODS (4.6 mmφ×250 mm: manufactured by Chemicals Evaluation and Research Institute, Japan), at a column temperature of 35° C. The liquid A as a mobile phase, was a distilled water solution containing 0.1 mol/L of acetic acid, the liquid B was an acetonitrile solution containing 0.1 mol/L of acetic acid, and the measurement was conducted under the conditions of an injection amount of the sample of 20 μL and a UV detector wavelength of 280 nm.

### <Method for Measuring Tannin>

Tannin was measured by an iron tartrate method as an equivalent amount of gallic acid by using ethyl gallate as a standard solution. (Reference literature: “Green Tea Polyphenols”, Functional Material Effective Utilization Technology Series on Diet, No. 10.) Was 5 mL of the sample color-developed with 5 mL of an iron tartrate standard solution, the volume was adjusted to 25 mL with phosphate buffer, the absorbance was measured at 540 nm, and tannin was obtained from a calibration curve prepared by using ethyl gallate.

Preparation of iron tartrate standard solution: 100 mg of ferrous sulfate heptahydrate and 500 mg of sodium potassium tartrate were adjusted to 100 mL with distilled water.

Preparation of phosphate buffer: 1/15 mol/L disodium hydrogen phosphate solution and 1/15 mol/L sodium dihydrogen phosphate solution were mixed to adjust its pH to 7.5.

### <Method for Measuring Rutin>

A sample solution was filtered by a filter (0.45 um), and analyzed by a gradient method by using high performance liquid chromatograph (model: Waters 2695, manufactured by WATERS) attaching a column (Shimpach VP ODS, 150×4.6 mm I.D.) at a column temperature of 40° C. Liquid A as a mobile phase was a distilled water aqueous solution containing 0.05% of phosphoric acid, and liquid B was a methanol solution, and the measurement was conducted under conditions of a flow rate of 1 mL/min, a sample injection amount of 10 μL and a UV detector wavelength of 368 nm. The conditions for the gradient are as follows.

| | Concentration of | Concentration of |
|---|---|---|
| Time (min) | liquid A (vol %) | liquid B (vol %) |
| 0.0 | 95 | 5 |
| 20.0 | 80 | 20 |
| 40.0 | 30 | 70 |
| 41.0 | 0 | 100 |
| 46.0 | 0 | 100 |
| 47.0 | 95 | 5 |
| 60.0 | 95 | 5 |

### <Measurement of Flavonols>

### (1) Hydrolysis of Sample

Were 200 μL of mercaptoethanol and 500 μL of 2N hydrochloric acid added to 5 mL of a sample solution.

Thereafter the sample was heated in a dry block bath (manufactured by As One Corporation) at 120° C. for 40 minutes and cooled.

### (2) Analysis

The myricetin, quercetin and kaempferol that were present in the sample solution after the hydrolysis were quantified with high performance liquid chromatography. The quantification was conducted by a gradient method, and the analysis method was the same as that in the above-mentioned “Method for measuring rutin”.

### (3) Total Amount of Flavonols

Total amount of flavonols was obtained as the sum of the amounts of the myricetin, quercetin and kaempferol which were quantified by the above-mentioned analysis.

### <Method for Measuring Caffeine>

The following apparatus was used.

HPLC (manufactured by Hitachi, Ltd.)

Plotter: D-2500, detector: L-4200

Pump: L-7100, auto sampler: L-7200

Column: Inertsil ODS-2, inner diameter 2.1 mm×length 250 mm

The analysis conditions are as follows.

Injection amount of sample: 10 μL, flow amount: 1.0 mL/min

UV absorptiometer detection wavelength: 280 nm

Eluant A: aqueous solution containing acetic acid in an amount of 0.1 mol/L, eluant B: acetonitrile solution containing acetic acid in an amount of 0.1 mol/L

Conditions for Concentration Gradient (Vol %)

| Time (min) | Eluant A | Eluant B |
|---|---|---|
| 0 | 97 | 3 |
| 5 | 97 | 3 |
| 37 | 80 | 20 |
| 43 | 80 | 20 |
| 43.5 | 0 | 100 |
| 48.5 | 0 | 100 |
| 49 | 97 | 3 |
| 62 | 97 | 3 |

The retention time of caffeine was 27.2 min.

The mass % was obtained from the area % obtained here.

### <Method for Measuring Moisture Ratio of Catechin Preparation>

Was 2 to 3 g of a catechin preparation weighed and put into a thermostat bath set to 105° C. for 2 hours. The difference between the masses before and after the putting into the bath was defined as a moisture content, and the percentage of the value obtained by dividing the moisture content by the mass of the catechin preparation before putting into the bath was considered as the moisture ratio of the catechin preparation.

### <Method for Measuring Solid Content>

Solid content was calculated by the following formula after weighing about 1 g of a sample, drying the sample at 105° C. for 3 hours or more and weighing.

Solid content=(mass after drying/mass before drying)×100

### <Method for Measuring Turbidity>

The measurement of the turbidity was conducted according to JIS K0400-9-10 (Water quality-Measurement of Turbidity). The measurement device was a haze-transmittance meter (HM-150, integrating-sphere type, manufactured by Murakami Color Research Laboratory, Ltd.), and an absorb cell of 10 mm was used. A formazin standard solution (400 FTU (formazin)) (manufactured by Kanto Kagaku) was diluted to prepare a [5 to 100 FTU (formazin)] calibration curve. The intensity of the scattered light (TD) and the intensity of the whole transmitted light (Tt) in a sample prepared as an aqueous solution with 0.5% of a solid content were measured, Td/Tt×100 was calculated, and the integrating-sphere turbidity [FTU (formazin)] of the sample was obtained from a calibration curve.

### <Method for Measuring Absorbance>

Using Hitachi Spectrophotometer (U-3310), the absorbance at 400 to 900 nm of an aqueous solution with 1.0% of a solid content of the sample was measured by using a dispocell having an optical path length of 10 mm (made of PMMA). The value at 671.5 nm at that time was defined as an absorbance (Abs).

### <Method for Measuring Viscosity>

In the viscosity measurement, a type B viscometer (20° C.) was used, and the average value of three times was defined as a measured value. The measurement sample was stirred in advance in a rotary stirrer for several hours to thereby dissolve sufficiently.

<Preparation of Catechin Preparation (i)>

Was 100 g of a caffeine-containing catechin composition (POLYPHENONE HG, manufactured by Tokyo Food Techno) suspended in 490.9 g of a 95% ethanol aqueous solution under stirring conditions of an ordinary temperature and 250 rpm, 20 g of active carbon (KURARAYCOAL GLC, trade name, manufactured by Kuraray Chemical Co., Ltd.) and 100 g of acidic white clay (MIZUKA ACE #600, trade name, manufactured by Mizusawa Industrial Chemicals, Ltd) were added thereto, and stirring was continued for about 10 minutes. Was 409.1 g of a 40% ethanol aqueous solution then added dropwise thereto over 10 minutes, and thereafter a stirring treatment for about 30 minutes was continued at room temperature. The active carbon and precipitated product were then filtered off by a filter paper No. 2, and thereafter filtration was conducted again by a 0.2 μm membrane filter. Finally, 200 g of ion exchanged water was added to the filtrate, ethanol was distilled off at 40° C. and 25 Torr, and this was lyophilized to give a powdery catechin preparation (i).

For catechin preparations (v) and (vii), POLYPHENONE 70A (red ocher) and POL-JK (pale green) manufactured by Mitsui Norin Co., Ltd. were respectively used as caffeine-containing catechin compositions.

Catechin preparations (ii) to (iv) were prepared by blending the catechin preparations (vii) and (i).

### (Preparation of Catechin Preparation (Vi))

Green tea leaves (macrophylla) were extracted in hot water, and the extract was spray-dried to give a green tea extract. In this green tea extract, the concentration of non-polymer catechins was 30.8%.

Subsequently, this green tea extract was diluted with ion exchanged water so that the concentration of the non-polymer catechins became 1%. Subsequently, 800 g of this diluted solution was adsorbed on 200 mL of a styrene-based synthetic adsorbent (SP70, trade name, manufactured by Mitsubishi Chemical Corporation) filled in a column (inner diameter 50 mm×height 180 mm, volume 353.3 mL). Subsequently, 300 mL of ion exchanged water and 400 mL of a 30% ethanol aqueous solution were fed to the synthetic adsorbent in this order to elute the non-polymer catechins. Subsequently, 400 mL of a 50% ethanol aqueous solution was fed to the synthetic adsorbent to elute a polyphenol composition. All of these fractionation operations were conducted while adjusting the flow amount so as to give a flow rate SV=0.8 to 1.2 [h⁻¹]. Subsequently, the insoluble substances were removed from the obtained eluate by concentrating the eluate under a reduced pressure to remove ethanol, and the moisture was removed by lyophilization to give a catechin preparation (vi) (pale yellow). The values of the componential analysis of the above-mentioned respective catechin preparations are shown in Table 1.

TABLE 1

| Component content in | | | | | | | | |
|---|---|---|---|---|---|---|---|---|
| catechin preparation | Unit | (i) | (ii) | (iii) | (iv) | (v) | (vi) | (vii) |
| Non-polymer catechins | (%) | 64.1 | 55.1 | 46.0 | 40.0 | 77.4 | 78.1 | 34.0 |
| Tannin | (%) | 67.3 | 59.4 | 51.6 | 46.3 | 99.0 | 75.0 | 41.1 |
| Non-polymer catechins/Tannin | (mass ratio) | 0.95 | 0.91 | 0.88 | 0.85 | 0.78 | 1.041 | 0.83 |
| (D) + (E) | (%) | 26.70 | 22.92 | 19.14 | 16.62 | 60.46 | 29.70 | 14.10 |
| (F) Rutin | (%) | 0.73 | 0.89 | 1.05 | 1.15 | 1.03 | 0.54 | 1.26 |
| Caffeine | (%) | 4.06 | 4.62 | 5.16 | 5.56 | 0.20 | 0.30 | 5.93 |
| (A) + (B) + (C) | (%) | 1.04 | 1.79 | 1.54 | 1.71 | 1.52 | 0.79 | 1.88 |
| ((A) + (B) + (C))/((D) + (E)) | (mass ratio) | 0.0388 | 0.0780 | 0.0807 | 0.1030 | 0.0252 | 0.0265 | 0.1337 |
| Moisture ratio | (%) | 3.2 | 4.3 | 5.4 | 6.1 | 3.5 | 2.9 | 6.8 |
| Turbidity of aqueous | (formazin) | <1 | 10 | 21 | 32 | 1 | 0 | 58 |
| solution with 0.5% solid | | | | | | | | |
| content | | | | | | | | |
| Absorbance (671.5 nm) | (Abs) | 0.01 | 0.12 | 0.23 | 0.32 | 0.06 | 0.001 | 0.65 |
| of aqueous solution with | | | | | | | | |
| 1.0% solid content | | | | | | | | |
| Viscosity of aqueous | (mPa · s) | 18 | 48 | 154 | 286 | 25 | 20 | 473 |
| solution with 40% solid | | | | | | | | |
| content | | | | | | | | |

(A) myricetin,
(B) quercetin,
(C) kaempferol,
(D) epigallocatechin gallate,
(E) gallocatechin gallate

### Examples

### Production and Evaluation of Catechin-Containing Frosted Cereal Foods

Saccharide solutions each containing a catechin preparation were prepared at the incorporation ratios shown in Table 2. First, 2.8 g of ion exchanged water was put into a disposable aluminum cup (50 ml volume, upper (lower) diameter×depth (mm) φ61 (φ42)×33), and the any one of catechin preparations (i) to (vii) were weighed and dissolved therein so as to give the blending ratio shown in Table 2. Was 10.00 g of superfine sugar (manufactured by Mitsui Sugar Co., Ltd.) incorporated therein to prepare a slurry-like saccharide solution containing the purified catechin preparation. This disposable aluminum cup was put on a hot plate adjusted to 100° C. and stirred until the superfine sugar in the slurry-like saccharide solution containing the purified catechin preparation dissolved.

As an uncoated cereal food (a plane cereal food), a commercially available product of cornflakes (manufactured by Nissin Cisco Co., Ltd.) was used. Was 25.0 g of the plane cereal food put into a disposable aluminum tray (upper part size 130×112, lower part size 102×88, height 55 (mm)), and the tray was mounted on a hot plate. A part of the above-mentioned disposable aluminum cup containing the saccharide solution containing the catechin preparation was deformed into a beak form to make a spout, and the whole amount of the dissolved saccharide solution containing the catechin preparation was poured from the spout onto the whole of the plane cereal food. Furthermore, the plane cereal food was mixed by stirring with a spatula so that the surface of the plane cereal food was coated uniformly with the saccharide solution. Subsequently, the disposable aluminum tray was put into an oven that had been heated to 100 to 110° C. in advance, and the cereal food was stirred every 5 minutes and heat-dried for 15 minutes. The frosted cereal food was then allowed to cool under room temperature for 15 minutes and weighed. From this weighed value, the amount of the solid content (g) of the saccharide solution attached to the frosted cereal food was obtained.

The coating property of the saccharide solution containing the catechin preparation as used on the cereal food, and the appearance of the obtained frosted cereal food were evaluated according to the following criteria. Furthermore, after the evaluation, the frosted cereal food was heated for 2 hours in a thermostat dryer set to 105° C., the frosted cereal food was cooled in a desiccator until the temperature thereof returned to room temperature and the mass thereof was measured, and the content of the catechins with respect to the dry mass of the frosted cereal food was obtained from the percentage (%) of the non-polymer catechins in the catechin preparation. The results are shown in Table 2.

### (1) Coating Property on Cereal Food

Coating property was evaluated according to the following criteria, from the viewpoints whether or not the plane cereal food can be uniformly coated with the saccharide solution containing the catechin preparation when the plane cereal food is coated with the solution, and the easiness of the operation therefor.

5: Quite fine (can be coated quite uniformly)

4: Fine (can be coated uniformly)

3: Slightly fine (can be coated almost uniformly)

2: Slightly poor (the viscosity during heat-melting is high, and thus uniform coating is slightly difficult)

1: Poor (the viscosity during heat-melting is very high, and thus coating is impossible)

### (2) State of Appearance of Frosted Cereal Food

The amount of fragmented broken pieces of the cereal which were generated by the aggregation and the breaking due to stirring of the cereal pieces during the heat-drying of the cereal food coated with the saccharide solution containing the purified catechin preparation was evaluated by visual observation, and based on this, the appearance of the frosted cereal food was evaluated according to the following criteria.

3: Fine (small amounts of cereal broken pieces)

2: Slightly fine (slightly large amounts of cereal broken pieces)

1: Poor (large amounts of cereal broken pieces)

TABLE 2

| | | Examples | | | | | | | | | |
|---|---|---|---|---|---|---|---|---|---|---|---|
| | | 1 | 2 | 3 | 4 | 5 | 6 | 7 | 8 | 9 | 10 |
| Catechin preparation | | (i) | (i) | (i) | (i) | (i) | (i) | (vi) | (vi) | (v) | (v) |
| Saccharide | Catechin | 0.8 | 3.8 | 5.5 | 7.2 | 8.9 | 10.5 | 3.8 | 7.2 | 3.8 | 7.2 |
| solution | preparation | | | | | | | | | | |
| containing | Superfine | 77.5 | 75.2 | 73.8 | 72.5 | 71.2 | 69.9 | 75.2 | 72.5 | 75.2 | 72.5 |
| purified | sugar | | | | | | | | | | |
| catechin | Ion- | 21.7 | 21.1 | 20.7 | 20.3 | 19.9 | 19.6 | 21.1 | 20.3 | 21.1 | 20.3 |
| preparation | exchange | | | | | | | | | | |
| (parts) | water | | | | | | | | | | |
| | Total | 100 | 100 | 100 | 100 | 100 | 100 | 100 | 100 | 100 | 100 |
| Amount of solid content | | 25.60 | 25.65 | 25.58 | 26.10 | 25.62 | 27.57 | 26.42 | 27.01 | 26.76 | 26.76 |
| (%) coated in frosted | | | | | | | | | | | |
| cereal food | | | | | | | | | | | |
| Amount of catechins (%) | | 0.2 | 0.8 | 1.1 | 1.5 | 1.8 | 2.3 | 1.0 | 1.9 | 1.0 | 1.9 |
| with respect to dry mass | | | | | | | | | | | |
| of frosted cereal food | | | | | | | | | | | |
| Amount of solid content | | 1.0 | 4.8 | 7.0 | 9.1 | 11.1 | 13.0 | 4.8 | 9.1 | 4.8 | 9.1 |
| other than saccarides (%) | | | | | | | | | | | |
| in coating material | | | | | | | | | | | |
| Amount of catechins (%) | | 64.1 | 64.1 | 64.1 | 64.1 | 64.1 | 64.1 | 78.1 | 78.1 | 77.4 | 77.4 |
| in solid content other than | | | | | | | | | | | |
| saccarides in coating | | | | | | | | | | | |
| solution | | | | | | | | | | | |
| Evaluation | Coating | 5 | 5 | 5 | 5 | 4 | 3 | 5 | 4 | 5 | 4 |
| result | property | | | | | | | | | | |
| | State of | 3 | 3 | 3 | 3 | 3 | 3 | 3 | 3 | 3 | 3 |
| | appearance | | | | | | | | | | |

| | | | | | | | | Comparative | | Conventional |
|---|---|---|---|---|---|---|---|---|---|---|
| | | Examples | | | | | | examples | | example |
| | | 11 | 12 | 13 | 14 | 15 | 16 | 1 | 2 | 1 |
| Catechin preparation | | (ii) | (ii) | (iii) | (iii) | (iv) | (iv) | (vii) | (vii) | — |
| Saccharide | Catechin | 3.8 | 7.2 | 3.8 | 7.2 | 3.8 | 7.2 | 3.8 | 7.2 | — |
| solution | preparation | | | | | | | | | |
| containing | Superfine | 75.2 | 72.5 | 75.2 | 72.5 | 75.2 | 72.5 | 75.2 | 72.5 | 78.1 |
| purified | sugar | | | | | | | | | |
| catechin | Ion- | 21.1 | 20.3 | 21.1 | 20.3 | 21.1 | 20.3 | 21.1 | 20.3 | 21.9 |
| preparation | exchange | | | | | | | | | |
| (parts) | water | | | | | | | | | |
| | Total | 100 | 100 | 100 | 100 | 100 | 100 | 100 | 100 | 100 |
| Amount of solid content | | 25.75 | 26.64 | 26.73 | 26.63 | 26.44 | 26.95 | 26.51 | 26.51 | 25.33 |
| (%) coated in frosted | | | | | | | | | | |
| cereal food | | | | | | | | | | |
| Amount of catechins (%) | | 0.7 | 1.3 | 0.6 | 1.1 | 0.5 | 1.0 | 0.4 | 0.8 | 0.0 |
| with respect to dry mass | | | | | | | | | | |
| of frosted cereal food | | | | | | | | | | |
| Amount of solid content | | 4.8 | 9.1 | 4.8 | 9.1 | 4.8 | 9.1 | 4.8 | 9.1 | 0.0 |
| other than saccarides (%) | | | | | | | | | | |
| in coating material | | | | | | | | | | |
| Amount of catechins (%) | | 55.1 | 55.1 | 46.0 | 46.0 | 40.0 | 40.0 | 34.0 | 34.0 | 0.0 |
| in solid content other than | | | | | | | | | | |
| saccarides in coating | | | | | | | | | | |
| solution | | | | | | | | | | |
| Evaluation | Coating | 5 | 3 | 4 | 3 | 3 | 3 | 2 | 1 | 5 |
| result | property | | | | | | | | | |
| | State of | 3 | 3 | 3 | 3 | 2 | 2 | 1 | — | 3 |
| | appearance | | | | | | | | | |

It is found from the results in Table 1 and Table 2 that catechin-containing saccharide solutions that are excellent in coating property on plane cereals can be prepared by using the catechin preparations (i), (ii), (iii), (iv), (v) and (vi). Furthermore, it was found that frosted cereal foods with fine appearance can be produced by using these catechin-containing saccharide solutions, despite containing a large amount of catechins.

Having described our invention as related to the present embodiments, it is our intention that the invention not be limited by any of the details of the description, unless otherwise specified, but rather be construed broadly within its spirit and scope as set out in the accompanying claims.

This application claims priority on Patent Application No. 2010-210899 filed in Japan on Sep. 21, 2010, which is entirely herein incorporated by reference.

1. A frosted cereal food, comprising: catechins in an amount of 0.1 mass % or more with respect to the dry mass of the frosted cereal food, wherein
the frosted cereal food comprises a coating material comprising a solid content other than saccharides in an amount of 1 mass % or more, the solid content other than saccharides comprising the catechins in an amount of 40 mass % or more, and the coating material comprises (A) myricetin, (B) quercetin, (C) kaempferol, (D) epigallocatechin gallate and (E) gallocatechin gallate, where the ratio of the sum of the contents of (A), (B) and (C) to the sum of the contents of (D) and (E) (the content of (A)+(B)+(C)/the content of (D)+(E)) be 0.01 to 0.09 (mass ratio).

2. The frosted cereal food according to claim 1, wherein the catechins are incorporated into the coating material by blending a purified preparation of a catechins-containing plant extract into the coating material of the frosted cereal food.

3. (canceled)

4. A method of producing a frosted cereal food, comprising coating a cereal food with a saccharide solution comprising a purified preparation of a catechins-containing plant extract after forming the cereal food,
wherein the purified preparation of a catechins-containing plant extract comprises (A) myricetin, (B) quercetin, (C) kaempferol, (D) epigallocatechin gallate and (E) gallocatechin gallate, where the ratio of the sum of the contents of (A), (B) and (C) to the sum of the contents of (D) and (E) (the content of (A)+(B)+(C)/the content of (D)+(E)) be from 0.01 to 0.09 (mass ratio), and catechins amount to 40 mass % or more of the solid content of the purified preparation of a catechin-comprising plant extract, and
wherein the concentration of the catechins in the saccharide solution is from 0.01 to 15 mass %.

5. The method of producing a frosted cereal food according to claim 4, wherein a solid content other than saccharides amounts to 1 mass % or more of the solid content of the saccharide solution.

6. (canceled)

7. The method of producing a frosted cereal food according to claim 4, wherein the saccharide solution is coated so that the solid content of the saccharide solution be from 3 to 70 mass % in the frosted cereal food.

8. The method of producing a frosted cereal food according to claim 4, wherein the purified preparation of a catechin-comprising plant extract has a turbidity of 40 FTU (formazin) or less at an aqueous solution of 0.5 mass % solid content.

9. The method of producing a frosted cereal food according to claim 4, wherein the purified preparation of a catechin-comprising plant extract has an absorbance at 671.5 nm of 0.4 or less at an aqueous solution of 1.0 mass % solid content.

10. The frosted cereal food according to claim 1, wherein the content of the catechins in the frosted cereal food is from 0.2 to 10 mass % with respect to the dry mass of the frosted cereal food.

11. The frosted cereal food according to claim 2, wherein the purified preparation of a catechin-comprising plant extract is derived from at least one kind of plant selected from the group consisting of tea, grape, apple and soybean.

12. The frosted cereal food according to claim 2, wherein the amount of tannin in the solid content of the purified preparation of a catechin-comprising plant extract is 40 mass % or more.

13. The frosted cereal food according to claim 2, wherein the amount of rutin in the solid content of the purified preparation of a catechin-comprising plant extract is from 0.0001 to 2 mass %.

14. The frosted cereal food according to claim 2, wherein the amount of caffeine in the solid content of the purified preparation of a catechin-comprising plant extract is from 0.0001 to 10 mass %.

15. The frosted cereal food according to claim 2, wherein the purified preparation of a catechin-comprising plant extract is prepared by contacting a green tea extract with an active carbon, and an acid clay and/or active clay.

16. The method of producing a frosted cereal food according to claim 4, wherein the coating is conducted by ejecting the saccharide solution comprising the purified preparation of a catechin-comprising plant extract to the formed cereal food.

17. The method of producing a frosted cereal food according to claim 4, wherein the coating is conducted by soaking the formed cereal food in the saccharide solution comprising the purified preparation of a catechin-comprising plant extract.
